(19) United States
(12) Patent Application Publication
(10) Pub. No.: US 2026/0120257 A1
(43) Pub. Date: Apr. 30, 2026

(54) METHOD FOR ESTIMATING TONE MAPPING PARAMETERS AND CORRESPONDING APPARATUS

(71) Applicant: InterDigital CE Patent Holdings, SAS, Paris (FR)

(72) Inventors: Patrick Lopez, Livre sur Changeon (FR); Laurent Cauvin, CHEVAIGNE (FR); Nicolas Caramelli, RENNES (FR); David Touze, RENNES (FR); Patrick Morvan, LAILLE (FR)

(21) Appl. No.: 19/150,742

(22) PCT Filed: Jan. 16, 2024
(86) PCT No.: PCT/EP2024/050921

§ 371 Date: Jul. 24, 2025

(30) Foreign Application Priority Data
Jan. 24, 2023 (EP) 23305084.8
Feb. 16, 2023 (EP) 23305207.5
Oct. 27, 2023 (EP) 23306868.3

(51) Int. Cl. G06T 5/92; G06T 5/50

(52) U.S. Cl. CPC G06T 5/92; G06T 5/50; G06T 2207/20208

(57) ABSTRACT

A method for estimating tone mapping parameters is disclosed. A first tone mapping parameter representative of a white level offset is obtained (S500) for a standard dynamic range current picture. Then, the obtained first tone mapping parameter is compared (S502) with a corresponding first tone mapping parameter obtained for a previous picture. Finally, second tone mapping parameters are updated (S504, S506) for the standard dynamic range current picture responsive to the comparing, wherein the second tone mapping parameters comprise pairs of values representative of a tone mapping output fine tuning function.

### CROSS REFERENCE TO RELATED APPLICATIONS

This application claims the benefit of European Application No. 23305084.8, filed on Jan. 24, 2023, of European Application No. 23305207.5, filed on Feb. 16, 2023 and of European Application No. 23306868.3, filed on Oct. 27, 2023 which are incorporated herein by reference in their entirety.

### TECHNICAL FIELD

At least one of the present embodiments generally relates to a method and an apparatus for estimating tone mapping parameters.

### BACKGROUND

Recent advancements in display technologies are beginning to allow for an extended dynamic range of color, luminance and contrast in images to be displayed, for example a video or a still picture or image.

Technologies allowing for an extended dynamic range in luminance or brightness of images are known as high dynamic range (HDR) imaging. Although a number of HDR display devices have appeared, as well as image cameras capable of capturing images with an increased dynamic range, there is still a very limited number of HDR contents available. Solutions allowing extending the dynamic range of existing contents so that these contents can be displayed efficiently on HDR display devices are needed.

To prepare conventional (referred to as LDR for low dynamic range or as SDR for Standard dynamic range) content for HDR display devices, reverse or inverse tone mapping operators (ITMO) can be employed. ITMOs allow to generate HDR images from conventional (LDR or SDR) images, by using algorithms that process the luminance information of pixels in the images with the aim of recovering or recreating an appearance of a corresponding original scene. Typically, ITMOs take a conventional image as input, expand the luminance range of colors of this image in a global manner, and subsequently process highlights or bright regions locally to enhance an HDR appearance of colors in the image.

### SUMMARY

In one example, tone mapping parameters are determined from a standard dynamic range picture. To this aim, a first tone mapping parameter representative of a white level offset is obtained. Second tone mapping parameters that comprise pairs of values representative of a tone mapping output fine tuning function are then updated.

The update of the second tone mapping parameters is responsive to a comparison of the first tone mapping between a current picture and a previous picture.

In an example, both values of each pair representative of a tone mapping output fine tuning function are updated. In another example, at most one value per each pair is updated.

### BRIEF DESCRIPTION OF THE DRAWINGS

FIG. 1 illustrates a block diagram of an end-to-end system 1 in which various aspects and embodiments can be implemented;

FIG. 2 illustrates a detailed block diagram of a processing module according to an example;

FIG. 3A illustrates a detailed block diagram of an Inverse Tone Mapping (ITM) module according to an example;

FIG. 3B illustrates a detailed block diagram of an Inverse Tone Mapping (ITM) module according to another example;

FIG. 4 depicts a flowchart of a method for constructing a Tone Mapping Look-Up Table (TM LUT) according to an example;

FIG. 5 depicts an example of a curve of an opto-electronical transfer function (OETF curve);

FIG. 6 depicts an example of a curve of an electro-optical transfer function (EOTF curve);

FIG. 7 depicts a flowchart of the tone mapping operator according to an example;

FIG. 8A depicts a luma mapping curve defined as a piece-wise curve constructed out of three parts;

FIG. 8B depicts examples of ITMO and TMO curves in perceptual domain;

FIG. 9 depicts a flowchart of a method for estimating tone mapping parameters according to an example;

FIG. 10A depicts a flowchart of a method for updating FTF_X and FTF_Y values according to an example;

FIG. 10B depicts a flowchart of a method for updating FTF_X and FTF_Y values according to another example;

FIG. 11 depicts an example of a curve of a fine tuning function;

FIG. 12 depicts a flowchart of a method to derive values quantized on 8 and 12 bits of a fine tuning function from floating point values;

FIG. 13 depicts the differences of FTF_Y between consecutive frames with floating-point values (left side) and 8-bit quantized values (right side);

FIG. 14A illustrates schematically an example of hardware architecture of a processing module able to implement various aspects and examples;

FIG. 14B illustrates a block diagram of an example of a first system in which various aspects and examples are implemented;

FIG. 14C illustrates a block diagram of an example of a second system in which various aspects and examples are implemented;

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. At least one of the aspects generally relates to tone mapping parameters estimation, and at least one other aspect generally relates to transmitting a bitstream comprising the estimated tone mapping parameters or quantized versions thereof. These and other aspects can be implemented as a method, an apparatus, a computer readable storage medium having stored thereon instructions for estimating tone mapping parameters according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. Unless indicated otherwise, or technically precluded, the aspects described in this application can be used individually or in combination.

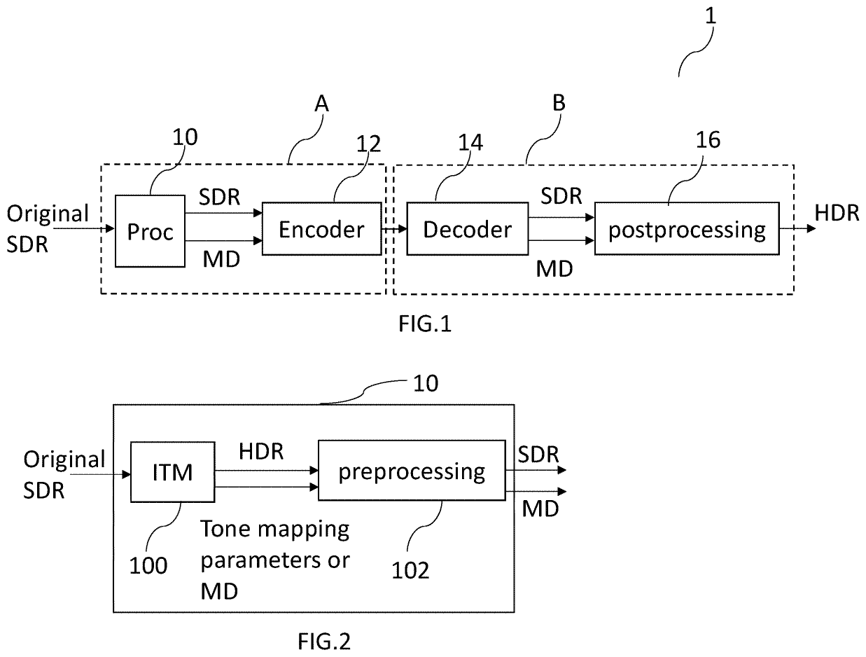

FIG. 1 illustrates a block diagram of an end-to-end system 1 in which various aspects and embodiments can be implemented. In FIG. 1, a device (not represented), e.g. a camera, a storage device, a computer or any device capable of delivering a SDR content, transmits the SDR content, named original SDR content, to a system A via a communication channel. The communication channel could be a wired (for example Ethernet) or a wireless (for example WiFi, 3G, 4G or 5G) network link. The original SDR content may be a fixed image or a video sequence. The system A is configured to determine and further encode a SDR content associated with metadata MD from which an HDR content can be reconstructed. The encoded SDR content associated with the metadata MD are thus transmitted to a system B. The system B is configured to reconstruct a HDR content from the obtained encoded data, i.e. SDR content associated with the metadata MD.

The system A comprises a processing module 10 that is configured to convert the original SDR content into a HDR content, i.e. applies an inverse tone mapping process (ITM) to the original SDR content to obtain the HDR content. The processing module 10 is further configured to decompose the HDR content into an SDR content associated with content dependent metadata MD, e.g. SL-HDR metadata as defined in section 6.2.5 of the ETSI document TS 103 433-1.

To this aim, the processing module 10 applies a tone mapping process on the HDR content. The whole process is defined such that the SDR content resulting from the HDR content decomposition is close to the original SDR content. Look-Up Tables (LUTs) may be used to implement SDR to HDR conversion (i.e. Inverse Tone Mapping (ITM)) and HDR to SDR decomposition (Tone Mapping (TM)). However, LUT are only given as examples for representing tone mapping and inverse tone mapping functions. The aspects described and contemplated in this application can be implemented in many different forms and are not limited to the use of LUTs for representing tone mapping and inverse tone mapping functions. The content dependent metadata MD comprise tone mapping parameters (e.g. white and black level offsets, shadow gain, etc) and additional parameters, e.g. characteristics of HDR/SDR pictures.

An example of a syntax of SL-HDR tone mapping parameters as defined in section 6.2.5 of the ETSI document TS 103 433-1 is given below:

| | No. of |
|---|---|
| Syntax | bits |
| luminance_mapping_variables( ) | |
| { | |
| tmInputSignalBlackLevelOffset | 8 |
| tmInputSignalWhiteLevelOffset | 8 |
| shadowGain | 8 |
| highlightGain | 8 |
| midToneWidthAdjFactor | 8 |
| tmOutputFineTuningNumVal | 4 |
| for( i = 0; i < tmOutputFineTuningNumVal; i++ ) { | |
| tmOutputFineTuningX[ i ] | 8 |
| tmOutputFineTuningY[ i ] | 8 |
| } | |
| } | |

The tmInputSignalBlackLevelOffset indicates the black level offset to be subtracted from the signal and is used to calculate the gain of the signal as a first step in the luminance mapping curve reconstruction process.

The tmInputSignalWhiteLevelOffset indicates the white level offset used to calculate the gain of the signal as a second step in the luminance mapping curve reconstruction process.

The shadowGain indicates the gain that is used to adjust the steepness of the luminance mapping curve in its shadow (darker) region.

The highlightGain indicates the gain that is used to adjust the steepness of the luminance mapping curve in its highlight (brighter) region.

The midToneWidthAdjFactor indicates the gain that is used to adjust the width of the luminance mapping curve in their mid-tone region.

tmOutputFineTuningNumVal specifies the number of pivot points in the piece-wise linear tone mapping output fine tuning function ftlum( ) that maps a local tone mapping input value to an adjusted one. In the ETSI document TS 103 433-1, tmOutputFineTuningNumVal∈[0; 10].

tmOutputFineTuningX indicates the xi values of the tone mapping output fine tuning function ftlum( ).

tmOutputFineTuningY indicates the yi values of the tone mapping output fine tuning function ftlum( ).

The system A further comprises an encoder 12 configured to encode the SDR content and the metadata MD into encoded data, e.g. into a bitstream. The encoder 12 may be an AVC ((ISO/CEI 14496-10/ITU-T H.264) encoder, an HEVC (ISO/IEC 23008-2—MPEG-H Part 2, High Efficiency Video Coding/ITU-T H.265)) encoder, a VVC (ISO/IEC 23090-3—MPEG-I, Versatile Video Coding/ITU-T H.266) encoder or any other encode, e.g. an ECM encoder. The present aspects are not limited to VVC, ECM or HEVC, and can be applied, for example, to other standards and recommendations, whether pre-existing or future-developed, and extensions of any such standards and recommendations (including VVC, ECM and HEVC). The metadata MD can for instance be carried in a SEI message (SEI stands for “Supplemental Enhancement Information”).

The encoded data may be stored on a storage medium or carried throughout an existing SDR distribution network with accompanying metadata conveyed on a specific channel or embedded in an SDR bitstream. The encoded data may thus be obtained (e.g. received) by the system B that is capable of reconstructing a HDR content from the obtained encoded data. The system B thus comprises a decoder 14 configured to decode the obtained encoded data into SDR content and metadata MD and a postprocessing module 16 configured to reconstruct the HDR content from the SDR content and the metadata MD. The decoder 14 may be an AVC decoder, an HEVC decoder, a VVC decoder or any other decoder. The decoder 14 implements the inverse steps of the encoder 12.

FIG. 2 illustrates a detailed block diagram of the processing module 10 according to an example. The processing module 10 comprises an inverse tone mapping (ITM) module 100 configured to convert the original SDR content into a HDR content associated with tone mapping parameters.

The processing module 10 further comprises a preprocessing module 102 connected to the output of the inverse tone mapping (ITM) module 100. The preprocessing module 102 is configured to decompose the HDR content into a SDR content associated with metadata MD, e.g. SL-HDR metadata as defined in section 6.2.5 of the ETSI document TS 103 433-1. To this aim, the preprocessing module 102 is configured to implement a tone mapping process. The metadata MD allow SDR-to-HDR reconstruction of the HDR content by the system B.

In a variant, the inverse tone mapping (ITM) module 100 is configured to generate the metadata MD and to send them to the preprocessing module 102, e.g. in the form of a SEI (Supplemental Enhancement Information) message such as the one defined in Table A.1 of the ETSI document TS 103 433-1 v1.4.1.

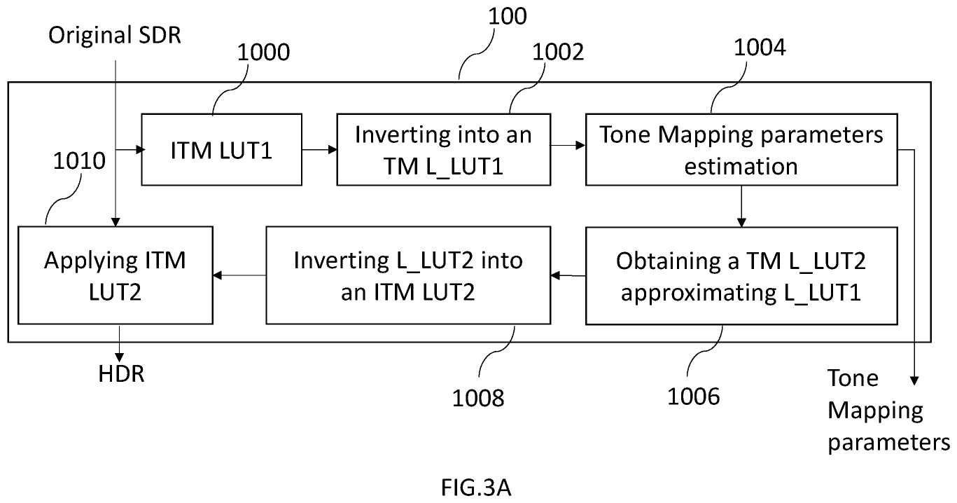

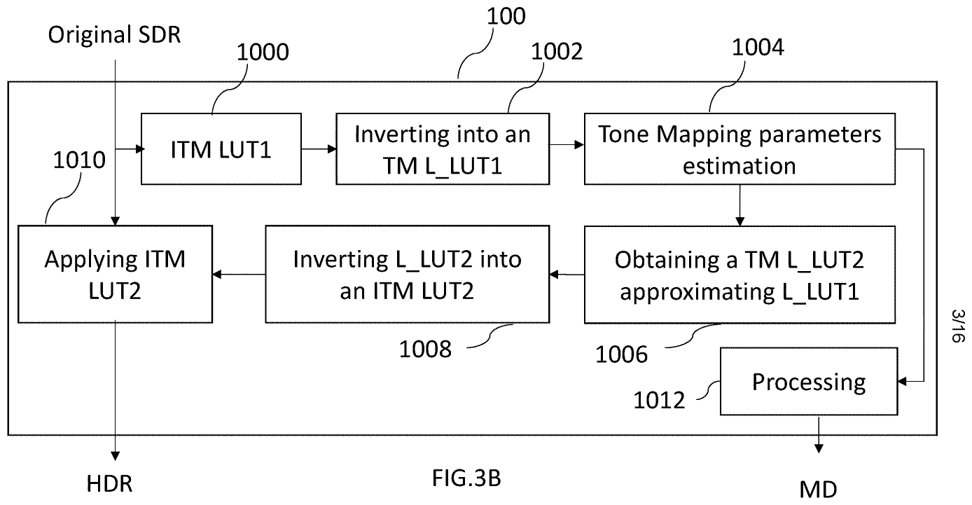

FIG. 3A illustrates a block diagram of the ITM module 100 according to an example. The ITM module 100 comprises a module 1000 configured to obtain information representative of an inverse tone mapping function. In an example, the information is in the form of an inverse tone mapping look-up table denoted ITM LUT1. The ITM LUT1 is for example obtained by analyzing the original SDR content, e.g. in the YCbCr format. As an example, document ITU-R BT.2446-1 describes, in its section 4.2, a method for converting SDR contents to HDR contents using the following ITM function (also called expansion function):

$${Y}_{HDR}^{′} = {Y}^{″ E ( {Y}^{″} )}$$

Where Y″=255.0×Y′, Y′ is the input SDR signal in the [0 . . . 1] range, E=a₁Y″²+b₁Y″+c₁ when Y″≤T, E=a₂Y″²+b₂Y″+c₂ when Y″>T, T=70, a₁=1.8712e-5, b₁=−2.7334e-3, c₁=1.3141, a₂=2.8305e-6, b₂=−7.4622e-4 and c₂=1.2528. As can be seen, the expansion function is based on a power function whose exponent depends on the luminance value of a current pixel. This is called a global expansion, which means that all input pixels having the same luminance at the input (SDR input) will have the same luminance at the output (HDR output). Another example of a ITM function is given in the following formula:

$${Y}_{HDR} ( Y ) = {Y}^{1.25} * 1023 / 25 {5}^{1.25} \qquad ( Eq . 1 )$$

in which the expanded value of Y in the range [0 . . . 255] is mapped in the [0 . . . 1023] range.

A ITM LUT1 with 1024 entries can then be filled using this formula for each value of Y between 0 and 255. The present principles are not limited to the above ITM functions. Any other method suitable to derive a ITM function for transforming a SDR content into an HDR content may be used.

The ITM module 100 further comprises a module 1002 configured to obtain information representative of a tone mapping function by inverting the inverse tone mapping function obtained by the module 1000. In an example, inverting the inverse tone mapping function obtained by the module 1000 comprises inverting the ITM LUT1 to obtain a so-called TM L_LUT1, i.e. a tone mapping LUT for HDR to SDR conversion. The tone mapping function can be expressed as follows in the case where the ITM function is defined by (Eq. 1): Y=(10^{(log} Y_{HDR}^{-A)})^{1/1.25}, with A=log(1023/255^{1.25})=1.7 10⁻³. TM L_LUT1 with 1024 entries can then be filled using this formula for each value of Y_{HDR} between 0 and 1023.

The ITM module 100 further comprises an estimation module 1004 configured to estimate tone mapping parameters (e.g. a white level offset and a fine tuning function) from L_LUT1 and a module 1006 configured to obtain a tone mapping LUT, denoted TM L_LUT2, that approximates L_LUT1 responsive to the estimated tone mapping parameters. Indeed, once the tone mapping parameters are estimated, one is able to compute TM L_LUT2 that approximates TM L_LUT1 responsive to the estimated tone mapping parameters. More generally, once the tone mapping parameters are estimated, one is able to compute another tone mapping function that approximates the tone mapping function obtained at the output of the module 1002.

The ITM module 100 also comprises a module 1008 configured to invert TM L_LUT2 (or more generally the tone mapping function obtained at the output module 1006) to obtain an inverse tone mapping LUT, denoted ITM LUT2, (or more generally an inverse tone mapping function) that is finally used by an ITM module 1010 to convert the original SDR content into the HDR content. The obtained HDR content and the estimated tone mapping parameters are then transmitted to the preprocessing module 102. From the estimated tone mapping parameters (possibly quantized on 8 or 12 bits for some of them) the preprocessing module 102 is able to derive a tone mapping LUT, denoted TM L_LUT. The preprocessing module 102 is then configured to apply the derived TM L_LUT on the HDR content to derive the SDR content to be transmitted along with the metadata MD to the encoder 12.

In a variant depicted on FIG. 3B, the ITM module 100 is configured to generate the metadata MD from the estimated tone mapping parameters and additional parameters, e.g. a country code, a terminal provider code, proprietary data, etc. To this aim, a processing module 1012 is configured to process the data to put them in an appropriate format, e.g. into a SL-HDR Information SEI message as defined in Table A.1 of the ETSI document TS 103 433-1 v1.4.1. The MD in the form of an SEI message may then be transmitted to the preprocessing module 102 with the HDR content.

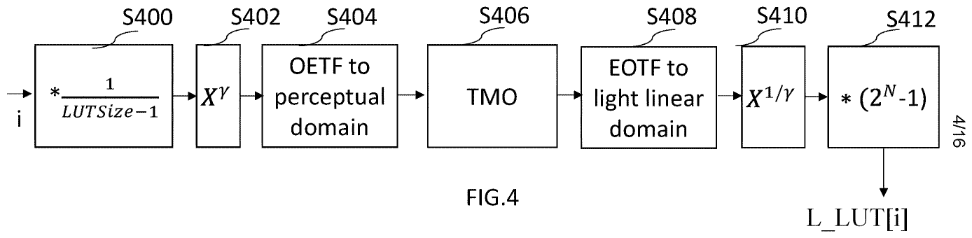

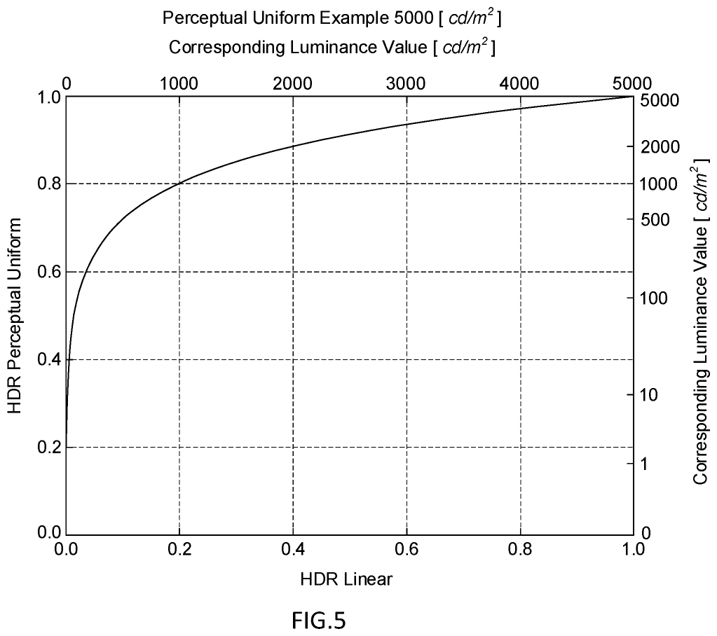

FIG. 4 depicts a flowchart of a method for constructing a TM LUT, denoted L_LUT, that may be used by the preprocessing module 102. The look-up table L_LUT[i], for luma values i in [0; LUTSize] implements a tone mapping function, where LUTSize is the size of the LUT, e.g. LUTSize=1023. For any input value i in [0; LUTSize], the value L_LUT[i] is derived by applying the following steps.

At a step S400, the input value i is multiplied by

$$\frac{1}{LUTSize - 1} .$$

The obtained value is then raised to the power γ at a step S402. As an example, γ=2.4.

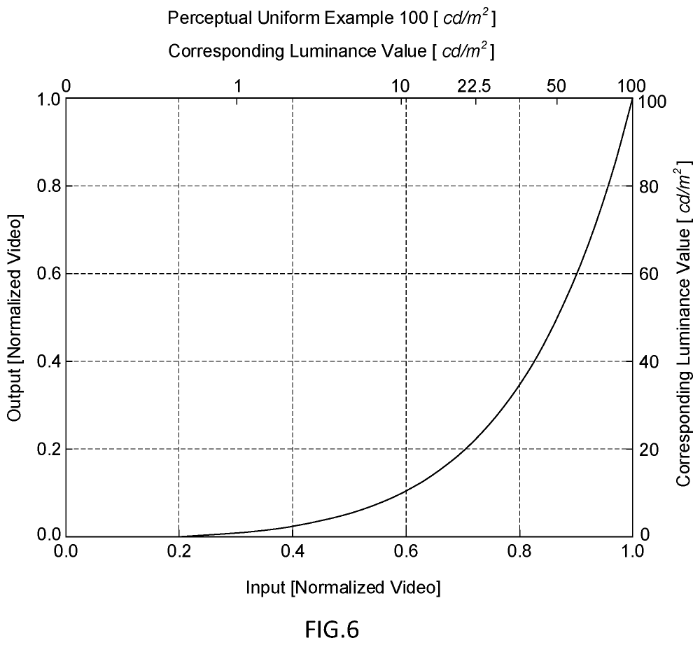

At a step S404, the value obtained at S402 is then converted by an opto-electronical transfer function (OETF) into a perceptual domain, also referred to as perceptually-uniform domain. An example of such an OETF curve is depicted on FIG. 5. At a step S406, the value obtained at S404 is tone mapped. The tone mapping is controlled by a plurality of tone mapping parameters, namely a white level offset (WS), a shadowGain, a highlightGain, a midToneWidthAdjFactor and further a fine tuning function. At a step S408, the obtained value is converted back from the perceptually-uniform domain to a linear-light domain by applying an electro-optical transfer function (EOTF). An example of such a curve is illustrated on FIG. 6. The value is then raised to the power of 1/γ at step S410 and multiplied by 2^{N}−1, N being an integer, in step S412 to obtain L_LUT[i]. In an example, N=10, in which case the L_LUT is quantized on 10 bits.

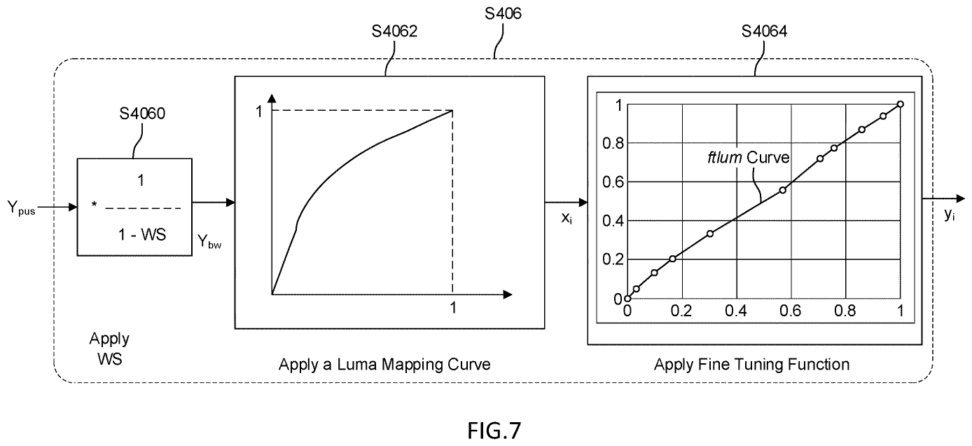

FIG. 7 depicts a flowchart detailing the tone mapping step S406 according to an example.

At a step S4060, the input signal Yₚᵤₛ is adapted by the white level offset WS as follows:

$${Y}_{bw} = \frac{Ypus}{1 - WS} .$$

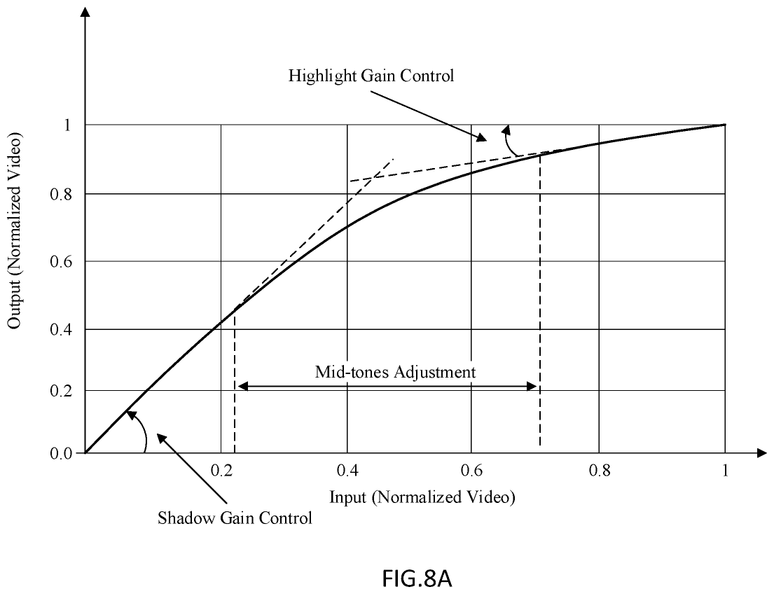

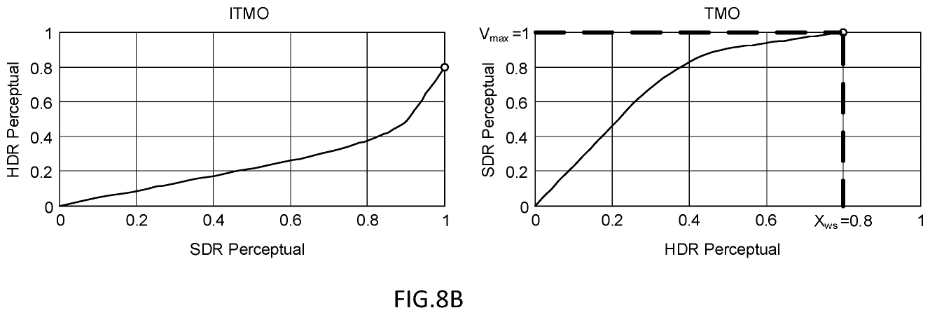

At a step S4062, a luma mapping curve is applied on Y_{bw} in the perceptually-uniform domain. The luma mapping curve is defined as a piece-wise curve constructed out of three parts as illustrated on FIG. 8A. The bottom section of the curve is linear, and its steepness is determined by the shadowGain. The upper section is also linear, and its steepness is determined by the highlightGain. The mid-section is a parabola providing a smooth bridge between the two linear sections. The width of the cross-over is determined by the midToneWidthAdjFactor.

Said otherwise, the function Map( ) associated with the luma mapping curve is defined as follows:

$$Map ( x ) = \{ \begin{matrix}SGC * x , & 0 \leq x \leq {x}_{SGC} \\ {ax}^{2} + bx + c , & {x}_{SGC} < x < {x}_{HGC} \\ HGC * x + 1 - HGC , & {x}_{HGC} \leq x \leq 1\end{matrix}$$

The values SGC, a, b, c, HCG, x_{SGC} and x_{HGC} are defined by equations C.21 to C.29 in section C.2.2.4 of the ETSI document TS 103 433-1 which is incorporated herein by reference in its entirety.

Back to FIG. 3, the tone mapping parameters are estimated by the module 1004 from L_LUT1. More precisely, knowing the input and output of the tone mapping method illustrated on FIG. 4, one is able to estimate the tone mapping parameters namely a first tone mapping parameter representative of a white level offset (WS) and second tone mapping parameters comprising pairs of values representative of a fine tuning function. These pairs of values are also called pivot point. The other tone mapping parameters take default values, e.g. black level offset is equal to 0, the highlight gain is equal to 2 and the midToneWidthAdjFactor is equal to 0. The shadow gain, denoted ShadowGain, is defined as follows:

$$ShadowGain = Quantif\_ 8 bits ( 4 * ( exp gain - 0.5 ) ) = 0.69 with exp gain = 0.673 and$$

$$Quantif\_ 8 bits ( \cdot ) is an 8 - bit quantization .$$

expgain is defined as follows:

$$exp gain = OETF\_HDR ( 100 nits ) = log ( ( {ρ}_{HDR} - 1 ) * {( \frac{100}{1000} )}^{\frac{1}{γ}} + 1 ) / log ( {ρ}_{HDR} ) = 0.673$$

$$where {ρ}_{HDR} = 32 * {( \frac{1000}{10000} )}^{\frac{1}{γ}} + 1 = 13.26$$

These values of expgain and ShadowGain are given for a 1000 nits HDR source. For a 2000 nits HDR, 2000 replaces 1000 in the above equations for determining ShadowGain.

The fine-tuning function ftlum(xᵢ) is applied on the input signal xᵢ to compute the output signal yi according to the following equation:

$$y i = \{ \begin{matrix}frlum ( {x}_{i} ) , & 0 \leq {x}_{i} \leq 1 \\ {x}_{i} , & otherwise\end{matrix}$$

The fine tuning function ftlum( ) is a piecewise linear function. The samples explicitly defining the fine tuning function ftlum( ) are pairs of values denoted (FTF_X, FTF_Y), also called pivot point. Said otherwise, each pair of values (FTF_X, FTF_Y) defines the coordinates (or the input and output values of the fine-tuning function) of a pivot point.

In order to estimate samples explicitly defining the fine tuning function ftlum( ), a basic approach consists in using default values for the tone mapping parameters (e.g. tmInputSignalBlackLevelOffset, tmInputSignalWhiteLevelOffset, shadowGain, highlightGain and midToneWidthAdjFactor as defined in ETSI document TS 103 433-1) and to use (FTF_X, FTF_Y) pairs to finely tune the ETSI-based TMO LUT to match the desired TM L_LUT1. The (FTF_X, FTF_Y) pairs are thus computed in such a way that the linear interpolation of these pivot points approximates the ideal fine tuning function, the one defined from TM L_LUT1.

This technique is efficient for a still picture since the original TMO curve is well estimated. However, on a video sequence, the original ITMO curve may change from one frame to the other. The optimization of the (FTF_X, FTF_Y) pairs achieved independently on each frame may generate very small variations of these (FTF_X, FTF_Y) values over the frame sequence. For some sequences, these variations can be annoying both on the HDR sequence generated at the output of the ITM module 1010, as well as at the output of the postprocessing module 16.

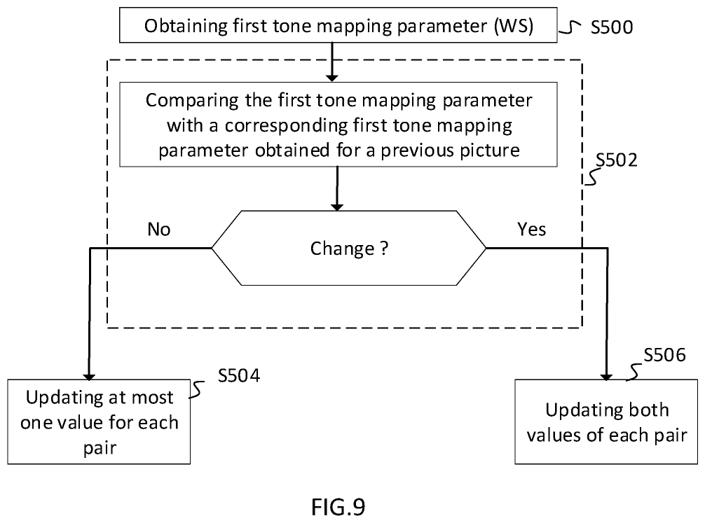

In contrast, the method for estimating tone mapping parameters disclosed below with reference to FIG. 9 makes it possible to avoid or at least limit these variations. More precisely, WS and FTF_X and FTF_Y are estimated so that the TMO in perceptual domain derived from estimated WS and FTF_X and FTF_Y matches the TMO derived from the ITMO initial curve itself obtained from ITM LUT1. The TMO is obtained from the ITMO by inverting the X-axis and Y-axis. A linear extrapolation is added if needed to reach HDR perceptual equal 1. Examples of ITMO and TMO curves in perceptual domain are depicted on FIG. 8B.

FIG. 9 depicts a flowchart of a method for estimating tone mapping parameters according to an example.

At a step S500, a first tone mapping parameter representative of a white level offset WS[k] is obtained for a current SDR picture Iₖ, k being an index identifying the picture. In one example, the first tone mapping parameter is the white level offset WS[k].

The white level offset WS[k] is derived from the initial L_LUT1. To this aim, the minimum X_{WS} value in HDR perceptual domain for which TMO(X_{WS})=Vₘₐₓ in SDR perceptual domain is determined wherein TMO( ) is the function applied at S406 which can be derived from L_LUT1. Indeed, from L_LUT1 one is able to derive the input and output of S406 and thus the TMO curve in perceptual domain. More precisely, the input of S406 is obtained by applying the steps S400 to S404 on i and the output is obtained by applying the reverse of the steps S412, S410 and S408 on L_LUT1[i]. As an example, in FIG. 8B (right side), the value Vₘₐₓ=1 and this value is reached for SDR perceptual when HDR perceptual equals 0.8. Thus, WS is computed as WS=1−0.8=0.2. The front ITMO module (1000 on FIG. 3) may decide to apply an autobrightspot level varying from frame to frame depending on the picture content. When the autobrightspot value is modified, the maximum value of the HDR level in perceptual domain is modified (cf. FIG. 8B). Thus, the WS is modified. Variations of other parameters may modify the WS, e.g. a MaxFall value, a diffuse white value (both values being expressed in nits). The MaxFall value can be defined as a maximum Frame Average Light Level (i.e. maximum average luminance level of an image). Consequently, the WS is computed on a frame by frame basis.

At a step S502, the first tone mapping parameter obtained for the current picture Iₖ is compared to a corresponding first tone mapping parameter representative of a white level offset obtained for a previous picture. In one example, the previous picture is the picture directly preceding the current picture in temporal order and thus identified by index k−1. In one example, the white level offset WS[k] is compared to a white level offset WS[k−1] obtained for the previous picture.

In the case where the white level offset WS[k] has changed, i.e. is different from WS[k−1], both values in each pair, i.e. FTF_X and FTF_Y, are updated at a step S506. Otherwise, i.e. the white level offset WS[k] has not changed, then at most one value in each pair, e.g. FTF_Y, is updated. In an example, the FTF_Y values are updated while the FTF_X values of the previous picture are used. In the case where the L_LUT1 and thus the ftlum curve change, even if the FTF_X values of the previous frame are used, the FTF_Y values may change and are thus updated by obtaining from the new ftlum curve the FTF_Y corresponding to the FTF_X values. This strategy guarantees that the FTF_Y values follow the initial curve described by the (xi, yi) pairs. In a variant, if WS[k] has not changed, the FTF_Y values of the previous frame are used. The FTF_X values are updated. This strategy guarantees that the FTF_X values follow the initial curve described by the (xi, yi) pairs.

In yet another variant not represented on FIG. 9, if WS[k] has not changed, both FTF_X and FTF_Y values of the previous frame are used. In this case, there is no update of FTF_X and FTF_Y.

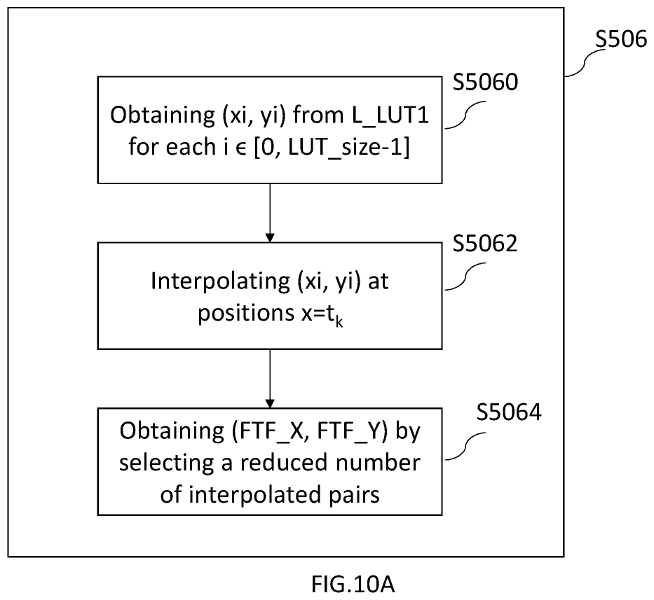

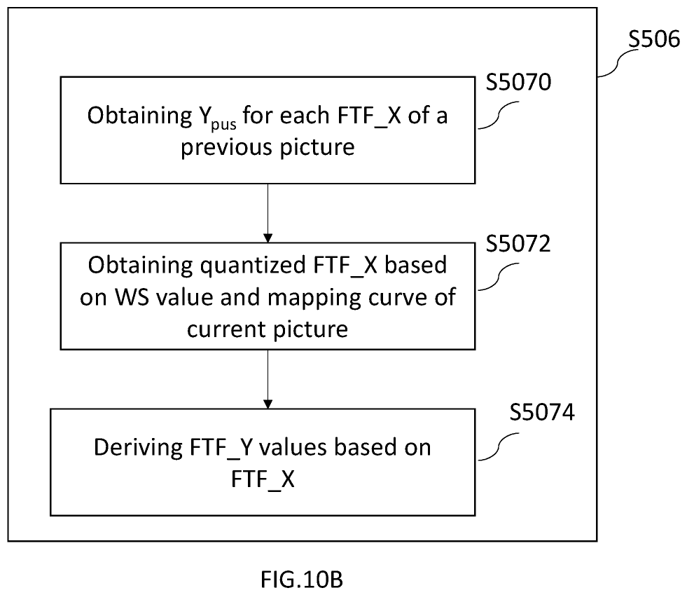

FIG. 10A depicts a flowchart of a method for updating, at S506, FTF_X and FTF_Y values according to an example.

In a step S5060, for each index i in [0, LUT1_size−1], a pair of values (xi, yi) is obtained from L_LUT1, where LUT1_size is the size of L_LUT1, xi is the input of the fine tuning function (S4064) and yi the output. To this aim, considering the steps of FIGS. 4 and 7, for each index i in [0, LUT_size−1], a floating value xᵢ in [0,1] is obtained after applying all processing steps up to and including the tone mapping steps described by WS, Shadow, Midtone and Highlight gains, i.e. S400, S402, S404, S4060 and S4062. The value used in S4060 is the WS obtained at S500. Default values are used at S4062 for shadowGain, highlightGain and midToneWidthAdjFactor.

The fine tuning function is in charge of converting this xᵢ value into:

$${y}_{i} = {EOTF}^{- 1} ( {( \frac{L\_UT1 [ i ]}{{2}^{N} - 1} )}^{γ} )$$

where the yᵢ depends on the L_LUT1. Indeed, with reference to FIG. 4, for each index i in [0, LUT_size−1], the output of the process is L_LUT1[i]. Therefore, from L_LUT1[i], one is able to obtain the output of the step S406 by applying the inverse steps of S412, S410 and S408. Therefore, the value L_LUT1[i] is first divided by 2^{N}−1 (inverse of step S412), the obtained value is then raised to the power 2.4 (inverse of step S410) and finally, the inverse EOTF (i.e. OETF) is applied. Hence, from L_LUT1, LUT_size pairs of (xᵢ,yᵢ) are obtained at S5060 for i in [0, LUT_size−1].

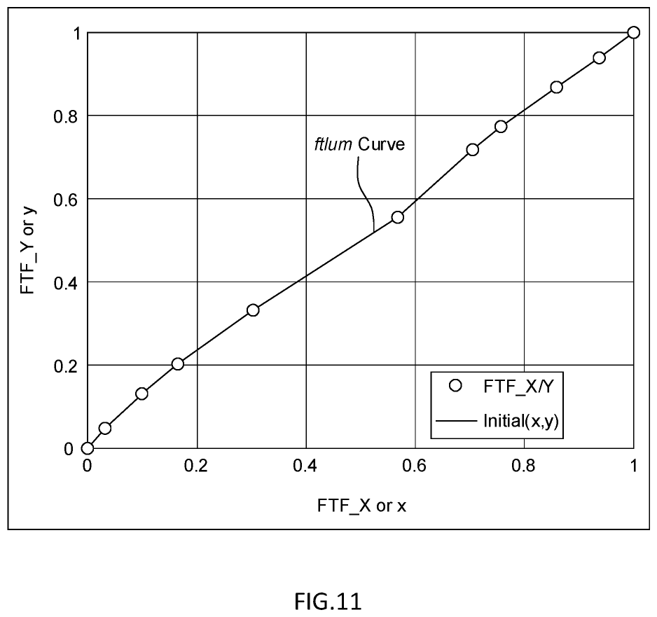

The estimation of pairs (FTF_X, FTF_Y) comprises selecting a reduced number of pairs (xᵢ,yᵢ) as shown in FIG. 11. On FIG. 11, 11 pairs (FTF_X, FTF_Y) are selected among the whole set of pairs (xᵢ,yᵢ). To this aim, at S5062, the LUT_size pairs of (xᵢ,yᵢ) are first interpolated at x=tₖ positions where tₖ=k/255 with k being an integer in [0,255]. The value 255 is just an example in the case of 8-bit quantization.

Thus, the final FTF_X values are a partition of the original set {tₖ, k in [0,255]}, and correspond to quantized values on 8 bits. Among the interpolated values P pairs (FTF_X, FTF_Y) are selected at S5064. In an example, P=10, i.e. 10 values among the 256 values x=tₖ are selected for FTF_X. In a variant, less than 10 values are selected. In another variant, more than 10 values are selected, e.g. 20. To this aim, interpolated pairs (xi, yi) are recursively deleted in order to keep a number P of pairs. A criterion based on a cost function is applied to determine which pair can be deleted. Several cost functions can be used such as a cost function corresponding to an error function between the L_LUT1 and the reconstructed L_LUT based on the estimated parameters or a cost function corresponding to an error function between an up-sampled version of the tone mapping output fine tuning function with the whole set of pairs, e.g. the 256 pairs, and an up-sampled version of the tone mapping output fine tuning function with the remaining pivot points. Interpolated pairs (xi, yi) are thus recursively deleted in order to decrease the cost function. More precisely, at each iteration step, the interpolated pair (xi,yi) whose deletion generates the minimum cost function value is selected to be the interpolated pair to be deleted.

The associated floating point FTF_Y values are the results of the interpolation of FTF_X values on the original LUT_size pairs of (xᵢ,yᵢ). So, the FTF_Y values do not correspond to quantized values on 8 bits, in that sense they are not multiples of 1/255. Other values may be used if quantizing on more or less than 8 bits. As an example, if quantizing on 10 bits, then the LUT_size pairs of (xᵢ,yᵢ) are first interpolated at x=tₖ positions where tₖ=k/1023 with k being an integer in [0,1023]. More generally, the (xᵢ,yᵢ) are first interpolated at x=tₖ positions where tₖ=k/(2^{M}−1) with k being an integer in [0, 2^{M}−1], M being an integer.

FIG. 10B depicts a flowchart of a method for updating, at S506, FTF_X and FTF_Y values of a current picture Iₖ according to another example.

In a step S5070, for each index i in [0, P−1], where P denotes the number of P pairs (FTF_X, FTF_Y), Y_{pus,i} is determined using successively inverse steps of S4062 and S4060.

More precisely, FTF_Xᵢ of a previous image Iₖ₋₁ considered as the output of S4062 is used as input of the inverse step of S4062. The luma mapping curve considered in this step is the luma mapping curve determined on the previous picture Iₖ₋₁. The input Y_{bw,i} of S4062 is thus derived by inverting the luma mapping curve associated with the previous picture Iₖ₋₁ using FTF_Xᵢ as input.

Then, using the inverse step of S4060, Y_{pus, i} is derived from Y_{bw,i} using the WS of the previous picture Iₖ₋₁.

In a step S5072, the updated FTF_Xᵢ is derived using S4060 and S4062 with WS and luma mapping curve of the current picture Iₖ using Y_{pus,i} as the input of S4060.

The updated FTF_Xᵢ is further quantized to k/255 with k in [0,255]. The value 255 is an example in the case of 8-bit quantization.

In a step 5074, a floating value i_{f} is determined for each quantized FTF_Xᵢ value of the current picture. This unique i_{f} value is obtained such that applying S400, S402, S404, S4060, S4062 on i_{f} provides quantized FTF_Xᵢ as output of S4062.

For this i_{f} floating value, L_LUT1[i_{f}] is computed by interpolation means using L_LUT1[i] with i an integer.

Finally, FTF_Yᵢ associated with FTF_Xᵢ is computed as:

$${FTF\_Y}_{i} = {EOTF}^{- 1} ( {( \frac{L\_LUT1 [ {i}_{f} ]}{{2}^{N} - 1} )}^{γ} )$$

Once the values WS, FTF_X and FTF_Y are estimated either by the method of FIG. 10A or FIG. 10B, the TM L_LUT2 and its inverse ITM LUT2 are obtained. More precisely, the floating-point values of FTF_Y are used for obtaining TM L_LUT2 and its inverse ITM LUT2 used in the SDR to HDR inverse tone mapping process 1010. More precisely, the TM L_LUT2 is obtained by applying the method depicted on FIGS. 4 and 7 using the estimated parameters (WS, 8-bit quantized points FTF_X and floating points FTF_Y) at step S406. This allows a better quality of the HDR picture.

In addition, the floating-point values of FTF_Y may be further quantized on 8 bits and the 8 bit quantized values of FTF_Y are transmitted to the preprocessing module 102 along with the 8-bit quantized points FTF_X values. These 8-bit quantized values (8-bit quantized points FTF_X and 8-bit quantized points FTF_Y) are also encoded and transmitted to be used by the postprocessing module 16. Indeed, according to ETSI specification, the preprocessing module 16 is expecting to receive 8-bit values. Any other quantization generates metadata MD not compliant with current ETSI specification. For perfect HDR roundtrip, the same 8-bit quantized values are used by the preprocessing module 102.

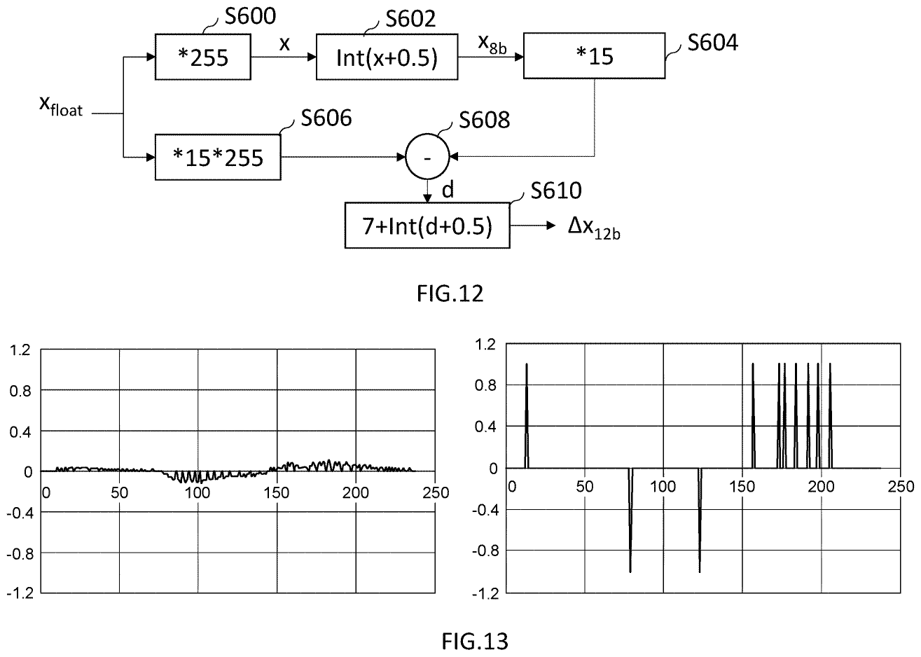

Alternatively, FTF_Y values can be quantized on more than 8 bits before being sent to the preprocessing module 102. As an example, the FTF_Y values can be quantized on 12 bits before being sent to the preprocessing module 102. In another example illustrated by FIG. 12, FTF_Y values quantized on 8 bits are transmitted to the preprocessing module 102 along with quantization differences allowing the preprocessing module 102 to reconstruct FTF_Y values quantized on 12 bits. This may improve the SDR accuracy, i.e. decrease the difference between the original SDR content and the SDR content at the output of the preprocessing module 102 at the price of degrading the HDR accuracy, i.e. increase the difference between the HDR content at the output of ITM module 100 and the HDR content reconstructed by the postprocessing module 16. The FTF_Y values quantized on 8-bit may still be encoded and transmitted to the postprocessing module 16 to be compliant with current ETSI specification.

In a variant, X and Y are exchanged. The examples disclosed above apply in the same way. Thus, the LUT_size pairs of (xᵢ,yᵢ) are first interpolated at y=tₖ positions where tₖ=k/255 with k being an integer in [0,255]. Thus, the final FTF_Y values are a partition of the original set {tₖ, k in [0,255]}, and correspond to quantized values on 8 bits. Among the interpolated values, P pairs (FTF_X, FTF_Y) are selected at S5064 as disclosed above. In an example, P=10, i.e. 10 values among the 256 values y=tₖ are selected for FTF_Y. In a variant, less than 10 values are selected. In another variant, more than 10 values are selected, e.g. 20. The associated floating point FTF_X values are the results of the interpolation of FTF_Y values on the original LUT_size pairs of (xᵢ,yᵢ). So, the FTF_X values do not correspond to quantized values on 8 bits, in that sense they are not multiples of 1/255.

Once the values WS, FTF_X and FTF_Y are estimated, the TM L_LUT2 and its inverse ITM LUT2 are obtained. More precisely, the floating-point values of FTF_X are used for obtaining TM L_LUT2 and its inverse ITM LUT2 used in the SDR to HDR inverse tone mapping process 1010. More precisely, the TM L_LUT2 is obtained by applying the method depicted on FIGS. 4 and 7 using the estimated parameters (WS, floating points FTF_X and 8-bit quantized points FTF_Y) at step S406. This allows a better quality of the HDR picture. In addition, the floating-point values of FTF_X may be further quantized on 8 bits and the 8 bit quantized values of FTF_X are transmitted to preprocessing module 102 along with the 8-bit quantized points FTF_Y values. These 8-bit quantized values (8-bit quantized points FTF_X and 8-bit quantized points FTF_Y) are also encoded and transmitted to be used by the postprocessing module 16. Indeed, according to ETSI specification, the preprocessing module 16 is expecting to receive 8-bit values. Any other quantization generates metadata MD not compliant with current ETSI specification. For perfect HDR roundtrip, the same 8-bit quantized values are used by the preprocessing module 102.

Alternatively, FTF_X values can be quantized on more than 8 bits before being sent to the preprocessing module 102. As an example, the FTF_X values can be quantized on 12 bits before being sent to the preprocessing module 102. In another example illustrated by FIG. 12, FTF_X values quantized on 8 bits are transmitted to the preprocessing module 102 along with quantization differences allowing the preprocessing module 102 to reconstruct FTF_X values quantized on 12 bits. The FTF_X values quantized on 8-bit may still be encoded and transmitted to the postprocessing module 16 to be compliant with current ETSI specification.

FIG. 12 depicts a flowchart of a method for obtaining fine tuning function values quantized on 8 and 12 bits from floating point values.

x_{float} being a floating-point value (a FTF_X value or a FTF_Y value), x_{float} is quantized on 8 bits. The quantized value is denoted x_{8b}. To this aim, x_{float} is multiplied by 255 at a step S600, i.e. x=255*x_{float}. At a step S602, the floating point value is converted into an integer value x_{8b}: x_{8b}=Int(x+0.5), where Int( ) is an operator that returns the integer part of its input.

The obtained value x_{8b} is the FTF_X value or FTF_Y value quantized on 8 bits.

A quantization difference is derived in order to be able to reconstruct a value x_{12b} quantized on 12 bits. To this aim, x_{8b} is multiplied by 15 at S604. In the same way, the floating-point value x_{float} is multiplied by 15 and 255 at a step S606. The difference d between the two outputs is obtained at S608 and is in the range [−7.5;7.5]. The obtained difference d is then processed at step S610 to obtain Δx_{12b} that it is in the range [0;14]. Therefore, Δx_{12b}=7+Int(d+0.5). Both values x_{8b} and Δx_{12b} may then be transmitted by the ITM 100 to the preprocessing module 102.

In an example, these data are transmitted in an SEI message such as the message disclosed in Table A.1. More precisely, the values FTF_X and FTF_Y quantized on 8 bits are transmitted as tone mapping_output_fine_tuning_x[i] and tone_mapping_output_fine_tuning_y[i] as in the following table (excerpt from Table A.1).

| | |
|---|---|
| (...) | |
| if( sl_hdr_payload_mode = = 0 ) { | |
| tone_mapping_input_signal_black_level_offset | u(8) |
| tone_mapping_input_signal_white_level_offset | u(8) |
| shadow_gain_control | u(8) |
| highlight_gain_control | u(8) |
| mid_tone_width_adjustment_factor | u(8) |
| tone_mapping_output_fine_tuning_num_val | u(4) |
| saturation_gain_num_val | u(4) |
| For ( i = 0; i < tone_mapping_output_fine_tuning_num_val; | |
| i++) { | |
| tone_mapping_output_fine_tuning_x[ i ] | u(8) |
| tone_mapping_output_fine_tuning_y[ i ] | u(8) |
| } | |
| (...) | |

tone_mapping_input_signal_black_level_offset indicates the black level offset.

tone_mapping_input_signal_white_level_offset indicates the white level offset.

shadow_gain_control indicates the adjustment to the shadow (darker) region of the luminance mapping curve

highlight_gain_control indicates the adjustment to the highlight (brighter) region of the luminance mapping curve.

Mid_tone_width_adjustment_factor indicates the adjustment to the mid-tone region of the tone mapping.

tone_mapping_output_fine_tuning_num_val indicates the number of pivot points in the piece-wise linear tone mapping output fine tuning function ftlum( )

saturation_gain_num_val indicates the number of pivot points to be adjusted in a piece-wise colour correction curve.

tone_mapping_output_fine_tuning_x[i] and tone_mapping_output_fine_tuning_y[i] specify the input and output values of the i-th adjusted pivot point for ftlum( ).

In addition, the quantization differences Δx_{12b} may be further transmitted to the preprocessing module 102. In an example, these values are transmitted in the same SEI message as the 8 bits values, more precisely in the last part of the SEI message reproduced below (excerpt from Table A.1). This part of the message may be used to transmit proprietary data.

| | |
|---|---|
| (...) | |
| if( sl_hdr_extension_present_flag ) { | |
| sl_hdr_extension_6bits | u(6) |
| sl_hdr_extension_length | u(10) |
| for( i = 0; i < sl_hdr_extension length; i++ ) | |
| sl_hdr_extension_data_byte[ i ] | u(8) |
| } | |

sl_hdr_extension_present_flag equal to 1 specifies that sl_hdr_extension_6 bits, sl_hdr_extension_length and sl_hdr_extension_data_byte[i] are present. sl_hdr_extension_6 bits may be used to indicate a proprietary solution. In an example, sl_hdr_extension_6 bits is set to 0.

sl_hdr_extension_length specifies the length of the SL-HDR extension data in bytes, not including the bits used for signalling sl_hdr_extension_length itself. sl_hdr_extension_data_byte[i] may have any value. In particular, in the present example, these syntax elements are used to transmit Δx_{12b}. More precisely, 2 successive bytes sl_hdr_extension_data_byte[i], i.e. 16 bits, are used to transmit a tag (on 6 bits) indicating that following information comprises two Δx_{12b} values for FTF_X or FTF_Y, each being on 4 bits. In the following table, ΔFTF_Y[k] represents the Δx_{12b} value for the k^{th} FTF_X pivot point, k being an integer in the range [0;9] in the case where the fine tuning function is defined by 10 pivot points. The bit denoted X below is ignored and thus may take any value.

| Data tag on 6 bits | | | | | | Data value on 10 bits | | | |
|---|---|---|---|---|---|---|---|---|---|
| 1 | 1 | 1 | 1 | 0 | 0 | X | X | ΔFTF_Y[0] | ΔFTF_Y[1] |
| 1 | 1 | 1 | 1 | 0 | 0 | X | X | ΔFTF_Y[2] | ΔFTF_Y[3] |
| 1 | 1 | 1 | 1 | 0 | 0 | X | X | ΔFTF_Y[4] | ΔFTF_Y[5] |
| 1 | 1 | 1 | 1 | 0 | 0 | X | X | ΔFTF_Y[6] | ΔFTF_Y[7] |
| 1 | 1 | 1 | 1 | 0 | 0 | X | X | ΔFTF_Y[8] | ΔFTF_Y[9] |

The tag is identical for all Δx_{12b} values. In the above example, the tag is equal to 0xF0. ΔFTF_Y[k], kϵ[0;9] are the 10 Δx_{12b} for FTF_Y.

From Δx_{12b} and x_{8b}, the preprocessing module 102 is able to reconstruct a value of x (i.e. a FTF_X or FTF_Y value) quantized on 12 bits as follows: x_{12b}=x_{8b}/255+(Δx_{12b}−7)/(15*255). The method disclosed above with respect to FIG. 12 may be applied to other examples than 8 and 12 bits in which case the values 15 and 255 are different.

FIG. 13 depicts the difference between FTF_Y[i0] values of consecutive frames. When the FTF_Y is in floating value, this difference is in a range [−0.12, 0.12] as depicted on the left of FIG. 12. When FTF_Y is quantized on 8 bits, this difference reaches +/−1 as depicted on the right of FIG. 13. This higher difference value explains why an annoying variation is sometimes observed. By using the floating values for deriving ITM LUT2 the quality of the HDR obtained at the output of the module 1010 is improved.

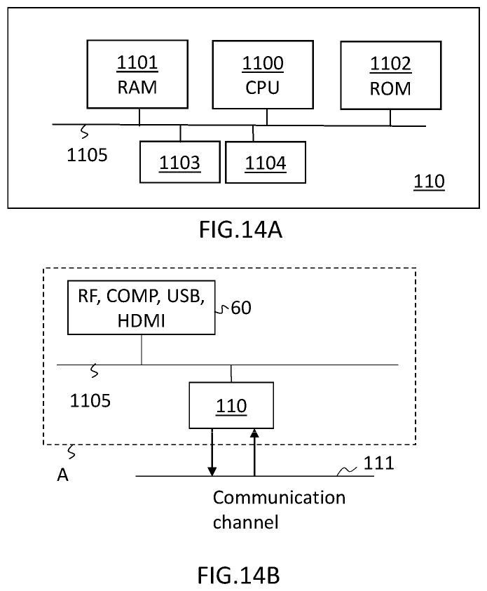

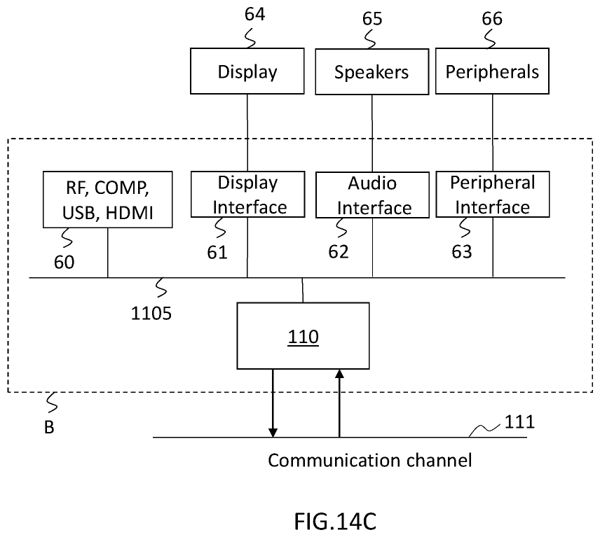

FIG. 14A illustrates schematically an example of an architecture of a processing module 110 comprised in the system A (respectively system B), in a system or module comprised in system A (respectively system B) such as the processing module 10, the postprocessing module 16, the encoder 12, the decoder 14, the ITM module 100, the preprocessing module 102 or any of the modules 1000 to 1010. The processing module 110 comprises, connected by a communication bus 1105: a processor or CPU (central processing unit) 1100 encompassing one or more microprocessors, general purpose computers, special purpose computers, and processors based on a multi-core architecture, as non-limiting examples; a random access memory (RAM) 1101; a read only memory (ROM) 1102; a storage unit 1103, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 1104 for exchanging data with other modules, devices, systems or equipment. The communication interface 1104 can include, but is not limited to, a transceiver configured to transmit and to receive data over a communication network. The communication interface 1104 can include, but is not limited to, a modem or a network card.

For example, the communication interface 1104 enables for instance the processing module 110 to receive HDR or SDR data and to output HDR or SDR data along with metadata MD.

The processor 1100 is capable of executing instructions loaded into the RAM 1101 from the ROM 1102, from an external memory (not shown), from a storage medium, or from a communication network. When the processing module 110 is powered up, the processor 1100 is capable of reading instructions from the RAM 1101 and executing them. These instructions form a computer program causing, for example, the implementation by the processor 1100 of inverse tone mapping or tone mapping processes comprising the processes described in relation to FIGS. 4, 7, 9 and 10.

All or some of the algorithms and steps of said processes may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 14B illustrates a block diagram of an example of the system A in which various aspects and embodiments are implemented.

System A can be embodied as a device including the various components and modules described above and is configured to perform one or more of the aspects and embodiments described in this document.

Examples of such devices include, but are not limited to, various electronic devices such as personal computers, laptop computers, a camera, a smartphone and a server. Elements or modules of system A, singly or in combination, can be embodied in a single integrated circuit (IC), multiple ICs, and/or discrete components. For example, in at least one embodiment, the system A comprises one processing module 110 that implement inverse tone mapping or tone mapping processes comprising the processes described in relation to FIGS. 4, 7, 9 and 10. In various embodiments, the system A is communicatively coupled to one or more other systems, or other electronic devices, via, for example, a communications bus or through dedicated input and/or output ports.

The input to the processing module 110 can be provided through various input modules as indicated in block 60. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 14B, include composite video.

In various embodiments, the input modules of block 60 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system A to other electronic devices across USB and/or HDMI connections. It is to be understood that various aspects of input processing, for example, Reed-Solomon error correction, can be implemented, for example, within a separate input processing IC or within the processing module 110 as necessary. Similarly, aspects of USB or HDMI interface processing can be implemented within separate interface ICs or within the processing module 110 as necessary. The demodulated, error corrected, and demultiplexed stream is provided to the processing module 110.

Various elements of system A can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system A, the processing module 110 is interconnected to other elements of said system A by the bus 1105.

The communication interface 1104 of the processing module 110 allows the system A to communicate on the communication network 111. The communication network 111 can be implemented, for example, within a wired and/or a wireless medium.

Data is streamed, or otherwise provided, to the system A, in various embodiments, using a wireless network such as a Wi-Fi network, for example IEEE 802.11 (IEEE refers to the Institute of Electrical and Electronics Engineers). The Wi-Fi signal of these embodiments is received over the communications network and the communications interface 1104 which are adapted for Wi-Fi communications. The communications network 111 of these embodiments is typically connected to an access point or router that provides access to external networks including the Internet for allowing streaming applications and other over-the-top communications. Still other embodiments provide streamed data to the system A using the RF connection of the input block 60. As indicated above, various embodiments provide data in a non-streaming manner.

FIG. 14C illustrates a block diagram of an example of system B in which various aspects and embodiments are implemented.

System B can be embodied as a device including various components or modules and is configured to generate a SDR or HDR content adapted to be displayed on adapted display devices. Examples of such system include, but are not limited to, various electronic systems such as personal computers, laptop computers, smartphones, tablet, TV, or set top boxes. Components of system B, singly or in combination, can be embodied in a single integrated circuit (IC), multiple ICs, and/or discrete components. For example, in at least one embodiment, the system B comprises one processing module 110 that implements a decoding of a SDR or HDR content. In various embodiments, the system B is communicatively coupled to one or more other systems, or other electronic devices, via, for example, a communications bus or through dedicated input and/or output ports.

The input to the processing module 110 can be provided through various input modules as indicated in block 60 already described in relation to FIG. 14B.

Various elements of system B can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system B, the processing module 110 is interconnected to other elements of said system B by the bus 1105.

The communication interface 1104 of the processing module 110 allows the system B to communicate on the communication network 111. The communication network 111 can be implemented, for example, within a wired and/or a wireless medium.

Data is streamed, or otherwise provided, to the system B, in various embodiments, using a wireless network such as a Wi-Fi network, for example IEEE 802.11 (IEEE refers to the Institute of Electrical and Electronics Engineers). The Wi-Fi signal of these embodiments is received over the communications network 111 and the communications interface 1104 which are adapted for Wi-Fi communications. The communications network 111 of these embodiments is typically connected to an access point or router that provides access to external networks including the Internet for allowing streaming applications and other over-the-top communications. Still other embodiments provide streamed data to the system B using the RF connection of the input block 60. As indicated above, various embodiments provide data in a non-streaming manner, for example, when the system B is a smartphone or a tablet. Additionally, various embodiments use wireless networks other than Wi-Fi, for example a cellular network or a Bluetooth network.

The system B can provide an output signal to various output devices using the communication network 111 or the bus 1105. For example, the system B can provide a decoded SDR or HDR signal.

The system B can provide an output signal to various output devices, including a display 64 (if for example the system B is a set top box provided a decoded SDR or HDR signal to a display device), speakers 65, and other peripheral devices 66. The display 64 of various embodiments includes one or more of, for example, a touchscreen display, an organic light-emitting diode (OLED) display, a curved display, and/or a foldable display. The display 64 can be for a television, a tablet, a laptop, a cell phone (mobile phone), or other devices. The display 64 can also be integrated with other components (for example, as in a smart phone), or separate (for example, an external monitor for a laptop). The display device 64 is SDR or HDR content compatible. The other peripheral devices 66 include, in various examples of embodiments, one or more of a stand-alone digital video disc (or digital versatile disc) (DVR, for both terms), a disk player, a stereo system, and/or a lighting system. Various embodiments use one or more peripheral devices 66 that provide a function based on the output of the system B. For example, a disk player performs the function of playing the output of the system B.

In various embodiments, control signals are communicated between the system B and the display 64, speakers 65, or other peripheral devices 66 using signaling such as AV.Link, Consumer Electronics Control (CEC), or other communications protocols that enable device-to-device control with or without user intervention. The output devices can be communicatively coupled to system B via dedicated connections through respective interfaces 61, 62, and 63. Alternatively, the output devices can be connected to system B using the communication network 111 via the communication interface 1104. The display 64 and speakers 65 can be integrated in a single unit with the other components of system B in an electronic device such as, for example, a television. In various embodiments, the display interface 61 includes a display driver, such as, for example, a timing controller (T Con) chip.

The display 64 and speakers 65 can alternatively be separate from one or more of the other components, for example, if the RF module of input 60 is part of a separate set-top box. In various embodiments in which the display 64 and speakers 65 are external components, the output signal can be provided via dedicated output connections, including, for example, HDMI ports, USB ports, or COMP outputs.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), smartphones, tablets, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations or embodiments can produce a variety of signals formatted to carry information that can be, for example, stored or transmitted. The information can include, for example, instructions for performing a method, or data produced by one of the described implementations or embodiments. For example, a signal can be formatted to carry a HDR or SDR image or video sequence and SL-HDR metadata of a described embodiment. Such a signal can be formatted, for example, as an electromagnetic wave (for example, using a radio frequency portion of spectrum) or as a baseband signal. The formatting can include, for example, encoding a HDR or SDR image or video sequence with SL-HDR metadata in an encoded stream and modulating a carrier with the encoded stream. The information that the signal carries can be, for example, analog or digital information. The signal can be transmitted over a variety of different wired or wireless links, as is known. The signal can be stored on a processor-readable medium.

We described above a number of embodiments. Features of these embodiments can be provided alone or in any combination.

In an example, a method for estimating tone mapping parameters is disclosed that comprises:
obtaining, for a standard dynamic range current picture, a first tone mapping parameter representative of a white level offset;
comparing the obtained first tone mapping parameter with a corresponding first tone mapping parameter obtained for a previous picture; and
updating, for the standard dynamic range current picture, second tone mapping parameters responsive to the comparing, wherein the second tone mapping parameters comprise pairs of values representative of a tone mapping output fine tuning function.

In an example, comparing the obtained first tone mapping parameter with a corresponding first tone mapping parameter obtained for a previous image comprises determining whether the obtained first tone mapping parameter is equal to the corresponding first tone mapping parameter obtained for the previous image.

In an example, obtaining, for a standard dynamic range current picture, a first tone mapping parameter representative of a white level offset comprises:
obtaining information representative of an inverse tone mapping function adapted to generate a high dynamic range picture from the standard dynamic range current picture;
obtaining information representative of a tone mapping function by inverting the inverse tone mapping function; and
determining a high dynamic range value for which an output standard dynamic range value of the tone mapping function is the highest, the first tone mapping parameter representative of the white level offset being equal to one minus the determined high dynamic range value.

In an example, the information representative of an inverse tone mapping function and the information representative of the tone mapping function are look-up tables.

In an example, updating, for the standard dynamic range current picture, second tone mapping parameters responsive to the comparing comprises updating both values in each pair in a case where the obtained first tone mapping parameter is not equal to the corresponding first tone mapping parameter and updating at most one value in each pair in a case where the obtained first tone mapping parameter is equal to the corresponding first tone mapping parameter.

In an example, updating at most one value in each pair comprises:
obtaining information representative of a fine tuning function from the information representative of a tone mapping function; and
updating, for each pair, the at most one value responsive to both the information representative of a fine tuning function and the other value of the pair determined for the previous picture.

In an example, updating both values in each pair comprises:
obtaining information representative of a fine tuning function from the information representative of a tone mapping function;
interpolating pairs of values at positions k/(2^{M}−1) responsive to the obtained information representative of a fine tuning function, k and M being integers and kϵ[0; 2^{M}−1]; and
selecting a subset of the interpolated pairs.

In an example, selecting a subset of the interpolated pairs comprises deleting recursively a pair of values in order to decrease a cost function.

An apparatus comprising one or more processors and at least one memory coupled to the one or more processors is also disclosed, wherein the one or more processors are configured to perform the method according to any of the above examples.

A signal generated using the method of any of the above examples or using the apparatus is also disclosed.

A computer program comprising program code instructions for implementing the method of any one of the above examples when executed by a processor is disclosed.

A non-transitory information storage medium storing program code instructions for implementing the method of any one of the above examples is disclosed.

Further, embodiments can include one or more of the following features, devices, or aspects, alone or in any combination, across various claim categories and types:
A bitstream or signal that includes one or more of the described estimated tone mapping parameters, SDR or HDR data and/or SL-HDR metadata, or variations thereof.
Creating and/or transmitting and/or receiving and/or decoding a bitstream or signal that includes one or more of the described estimated tone mapping parameters, SDR or HDR data and/or SL-HDR metadata, or variations thereof.
A server, camera, TV, set-top box, cell phone, tablet, personal computer or other electronic device that performs at least one of the embodiments described.
A TV, set-top box, cell phone, tablet, personal computer or other electronic device that performs at least one of the embodiments described, and that displays (e.g. using a monitor, screen, or other type of display) a resulting image.
A TV, set-top box, cell phone, tablet, personal computer or other electronic device that tunes (e.g. using a tuner) a channel to receive a signal including encoded SDR or HDR data, estimated tone mapping parameters and/or SL-HDR metadata, and performs at least one of the embodiments described.
A TV, set-top box, cell phone, tablet, or other electronic device that receives (e.g. using an antenna) a signal over the air that includes SDR or HDR data, estimated tone mapping parameters and/or SL-HDR metadata, and performs at least one of the embodiments described.
A server, camera, cell phone, tablet, personal computer or other electronic device that tunes (e.g. using a tuner) a channel to transmit a signal including SDR or HDR data, estimated tone mapping parameters and/or SL-HDR metadata, and performs at least one of the embodiments described.
A server, camera, cell phone, tablet, personal computer or other electronic device that transmits (e.g. using an antenna) a signal over the air that includes SDR or HDR data, estimated tone mapping parameters and/or SL-HDR metadata, and performs at least one of the embodiments described.

1. A method for estimating tone mapping parameters comprising:
deriving, for a standard dynamic range current picture, a first tone mapping parameter from an initial tone mapping function, said first tone mapping parameter being representative of a white level offset;
comparing the first tone mapping parameter with a corresponding first tone mapping parameter obtained for a previous picture; and
responsive to the comparing, updating, for the standard dynamic range current picture, second tone mapping parameters, wherein the second tone mapping parameters are pairs of values representative of a tone mapping fine tuning function.

2. The method of claim 1, wherein comparing the first tone mapping parameter with the corresponding first tone mapping parameter obtained for the previous picture comprises determining whether the first tone mapping parameter is equal to the corresponding first tone mapping parameter obtained for the previous picture.

3. The method of claim 1, wherein deriving, for the standard dynamic range current picture, the first tone mapping parameter from the initial tone mapping function comprises:
obtaining an initial inverse tone mapping function adapted to generate a high dynamic range picture from the standard dynamic range current picture;
obtaining the initial tone mapping function by inverting the initial inverse tone mapping function; and
determining a high dynamic range value for which an output standard dynamic range value of the initial tone mapping function is the highest, the first tone mapping parameter being equal to one minus the determined high dynamic range value.

4. The method of claim 3, wherein the initial inverse tone mapping function and the initial tone mapping function are represented by look-up tables.

5. The method of claim 1, wherein updating, for the standard dynamic range current picture, second tone mapping parameters comprises updating both values in each pair in a case where the first tone mapping parameter is not equal to the corresponding first tone mapping parameter and updating at most one value in each pair in a case where the first tone mapping parameter is equal to the corresponding first tone mapping parameter.

6. The method of claim 5, wherein updating at most one value in each pair comprises:
obtaining a fine tuning function from the initial tone mapping function; and
updating, for each pair, the at most one value based on both the fine tuning function and the other value of the pair determined for the previous picture.

7. The method of claim 5, wherein updating both values in each pair comprises:
obtaining a fine tuning function from the initial tone mapping function;
interpolating pairs of values at positions k/(2^{M}−1) based on the fine tuning function, k and M being integers and kϵ[0; 2^{M}−1]; and
selecting a subset of the interpolated pairs.

8. The method of claim 7, wherein selecting the subset of the interpolated pairs comprises deleting recursively a pair of values in order to decrease a cost function.

9-12. (canceled)

13. The method of claim 1, wherein updating, for the standard dynamic range current picture, second tone mapping parameters comprises updating, for the standard dynamic range current picture, the second tone mapping parameters based on the initial tone mapping function.

14. An apparatus comprising one or more processors and at least one memory coupled to the one or more processors, wherein the one or more processors are configured to perform:
deriving, for a standard dynamic range current picture, a first tone mapping parameter from an initial tone mapping function, said first tone mapping parameter being representative of a white level offset;
comparing the first tone mapping parameter with a corresponding first tone mapping parameter obtained for a previous picture; and
responsive to the comparing, updating, for the standard dynamic range current picture, second tone mapping parameters, wherein the second tone mapping parameters are pairs of values representative of a tone mapping fine tuning function.

15. The apparatus of claim 14, wherein updating, for the standard dynamic range current picture, second tone mapping parameters comprises updating, for the standard dynamic range current picture, the second tone mapping parameters based on the initial tone mapping function.

16. The apparatus of claim 14, wherein comparing the first tone mapping parameter with the corresponding first tone mapping parameter obtained for the previous picture comprises determining whether the first tone mapping parameter is equal to the corresponding first tone mapping parameter obtained for the previous picture.

17. The apparatus of claim 14, wherein deriving, for the standard dynamic range current picture, the first tone mapping parameter from the initial tone mapping function comprises:
obtaining an initial inverse tone mapping function adapted to generate a high dynamic range picture from the standard dynamic range current picture;
obtaining the initial tone mapping function by inverting the initial inverse tone mapping function; and
determining a high dynamic range value for which an output standard dynamic range value of the initial tone mapping function is the highest, the first tone mapping parameter being equal to one minus the determined high dynamic range value.

18. The apparatus of claim 17, wherein the initial inverse tone mapping function and the initial tone mapping function are represented by look-up tables.

19. The apparatus of claim 14, wherein updating, for the standard dynamic range current picture, second tone mapping parameters comprises updating both values in each pair in a case where the first tone mapping parameter is not equal to the corresponding first tone mapping parameter and updating at most one value in each pair in a case where the first tone mapping parameter is equal to the corresponding first tone mapping parameter.

20. The apparatus of claim 19, wherein updating at most one value in each pair comprises:
obtaining a fine tuning function from the initial tone mapping function; and
updating, for each pair, the at most one value based on both the fine tuning function and the other value of the pair determined for the previous picture.

21. The apparatus of claim 19, wherein updating both values in each pair comprises:
obtaining a fine tuning function from the initial tone mapping function;
interpolating pairs of values at positions k/(2^{M}−1) based on the fine tuning function, k and M being integers and kϵ[0; 2^{M}−1]; and
selecting a subset of the interpolated pairs.

22. The apparatus of claim 21, wherein selecting the subset of the interpolated pairs comprises deleting recursively a pair of values in order to decrease a cost function.
